(19) United States
(12) Patent Application Publication
(10) Pub. No.: US 2012/0244469 A1
(43) Pub. Date: Sep. 27, 2012

(54) TUNABLE GLOSS USING AEROGEL CERAMIC FILLERS ADDED TO VITON COATINGS FOR FUSING APPLICATIONS

(75) Inventors: Edward Graham Zwartz, Mississauga (CA); Gordon Sisler, St. Catharines (CA); Kurt I. Halfyard, Mississauga (CA); Carolyn Moorlag, Mississauga (CA); Nicoleta Mihai, Oakville (CA); T. Brian McAneney, Burlington (CA); Guiqin Song, Milton (CA)

(73) Assignee: XEROX CORPORATION, Norwalk, CT (US)

(21) Appl. No.: 13/053,730

(22) Filed: Mar. 22, 2011

(51) Int. Cl. G03G 13/20; G03G 15/20

(52) U.S. Cl. 430/124.23; 399/320; 399/329; 399/333

(57) ABSTRACT

Exemplary embodiments provide materials, methods, and systems for a fuser member used in electrophotographic devices and processes, wherein the fuser member can include a coating material containing a plurality of aerogel fillers dispersed in and/or bonded to a polymer matrix for providing a desired gloss level of fused toner images.

### FIELD OF THE USE

The present teachings relate generally to coating materials for electrophotographic devices and processes and, more particularly, to coating materials that contain aerogel fillers for providing controllable image gloss levels.

### BACKGROUND

Electrophotographic marking is performed by exposing a light image representation of a desired document onto a substantially uniformly charged photoreceptor. In response to that light image, the photoreceptor discharges to create an electrostatic latent image of the desired document on the photoreceptor's surface. Toner particles are then deposited onto that latent image to form a toner image. That toner image is then transferred from the photoreceptor onto a print medium such as a sheet of paper. The transferred toner image is then fused to the print medium, usually using heat and/or pressure.

Gloss is a property of a surface that relates to specular reflection. Specular reflection is a sharply defined light beam resulting from reflection off a smooth, uniform surface. Gloss follows the law of reflection which states that when a ray of light reflects off a surface, the angle of incidence is equal to the angle of reflection. Gloss properties are generally measured in gardner gloss units (ggu) by a gloss meter.

Gloss acceptability levels for copies and prints are dependent on the market segment involved. A particular level of image gloss is typically desired depending on the application, for example, a textbook, or a photo-book and depending on the use environment, for example, for general office printing or graphic arts printing. The level of image gloss is also desired based on geography, e.g., Europe vs. North America, and/or substrates, e.g., matching between different substrates. The level of image gloss is significantly impacted by the toner formulation or the fusing process.

Conventional approaches to adjusting the printed image gloss include changing toner materials by varying the molecular weight of the resins used in the toner design. For example, four toner formulations have been developed to reduce the print gloss from original glossy DC8000 toner to less glossy Murano/DC8002 toner. The development of toner formulations is, however, costly.

Conventional approaches to adjusting the printed image gloss further include using additional equipment, such as dual fuser design or belts, to adjust the image gloss by applying varnish/overcoat to the print. Different gloss levels for varnish may provide varying gloss for the print runs. The additional equipment for conventional approaches, however, increases manufacturing cost.

### SUMMARY

According to various embodiments, the present teachings include a fuser member that includes a substrate and a topcoat layer disposed over the substrate. The topcoat layer can include a polymer matrix and a plurality of aerogel fillers. The plurality of aerogel fillers can be disposed in the polymer matrix in an amount ranging from about 0.1% to about 30% by weight of the total topcoat layer to provide the topcoat layer with an average surface roughness Sq value ranging from about 0.1 μm to about 15 μm.

According to various embodiments, the present teachings also include a fusing method of reducing gloss level in a final print. In this method, a contact arc can be formed between a coating material of a fuser roll and a pressure member. The coating material can include a plurality of aerogel fillers disposed in a fluoroelastomer. The plurality of aerogel fillers can be present in an amount ranging from about 0.5% to about 20% by weight of the total coating material to provide the coating material with an average surface roughness Sq value ranging from about 0.5 μm to about 10 μm. A print medium can pass through the contact arc such that toner images on the print medium contact the coating material and are fused on the print medium, wherein the fused toner images on the print medium can have a gloss level that is controllable in a range between about 70 ggu and about 10 ggu.

According to various embodiments, the present teachings further include a fuser member. The fuser member can include a substrate and a topcoat layer disposed over the substrate. The topcoat layer can include a plurality of aerogel fillers disposed in a fluoropolymer matrix in an amount to provide the topcoat layer with an average surface roughness Sq value ranging from about 1 μm to about 5 μm. The topcoat layer can be a gloss-controlling topcoat layer configured to fuse a toner image on a print medium with a gloss level ranging from about 70 ggu to about 10 ggu.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIGS. 1A-1B depict exemplary coating materials in accordance with various embodiments of the present teachings.

FIGS. 2A-2B depict exemplary fuser members using the coating materials of FIGS. 1A-1B in accordance with various embodiments of the present teachings.

FIG. 3 depicts an exemplary fusing system having the fuser members of FIGS. 2A-2B in accordance with various embodiments of the present teachings.

FIG. 4 depicts a relationship between the surface roughness of the fuser members in FIGS. 2A-2B and the gloss level of resulting prints in accordance with various embodiments of the present teachings.

FIG. 5 depicts exemplary print gloss results in accordance with various embodiments of the present teachings.

FIG. 6 compares gloss level as a function of print count for fuser rolls containing aerogel silica and fuser rolls containing other additive components in accordance with various embodiments of the present teachings.

It should be noted that some details of the figures have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

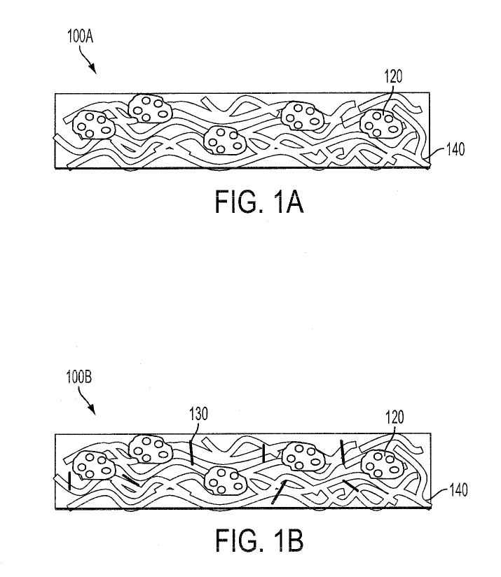

FIGS. 1A-1B depict exemplary coating materials 100A-B useful for electrophotographic devices and processes. The coating materials 100A-B can include a plurality of aerogel fillers 120 dispersed within a polymer matrix or material 140.

As used herein, the term “aerogel fillers” refers to a highly porous material with low mass density. The aerogel fillers can have high surface area, and high porosities. In one example, the aerogel fillers can be prepared by forming a gel with pore liquid and then removing pore liquid from the gel while substantially retaining a solid phase, i.e., the gel structure. In some cases, the term aerogel is used to indicate gels that have been dried so that the gel shrinks little during drying, preserving its porosity and related characteristics. In particular, aerogels are characterized by their unique structures that include a large number of small inter-connected pores. After the pore liquid is removed, the polymerized material is pyrolyzed in an inert atmosphere to form the aerogel.

The aerogel fillers can be in a form of particles, powders, or dispersions ranging in average volume particle size of from the sub-micron range to about 50 microns or more. The aerogel fillers 120 can be either formed initially as the desired sized particles, or can be formed as larger particles and then reduced in size to the desired size. For example, formed aerogel materials can be ground, or they can be directly formed as nano to micron sized aerogel particles. In embodiments, the aerogel fillers can have an average particle size of from about 5 nm to about 50 μm, or from about 1 μm or about 30 μm, or from about 5 μm or about 20 μm. In embodiments, the aerogel fillers can include one or more nano-sized primary particles, e.g., having an average particle size ranging from about 5 nm or about 20 nm. The aerogel fillers 120 can appear as well dispersed single particles or as agglomerates of more than one particle or groups of particles within the polymer material 140. In embodiments, the aerogel fillers 120 can have a shape that is spherical, or near-spherical, cylindrical, rod-like, bead-like, cubic, platelet-like, and the like.

The aerogel fillers 120 can have open-celled microporous or mesoporous structures. The aerogel fillers 120 can include a combination of multi-scaled pores including micron-sized pores, micropores (<2 nm), mesopores (between about 2 nm to about 50 nm), and/or macropores (>50 nm). In embodiments, the pores of aerogel fillers can have an average diameter of less than about 500 nm or less, or less than about 200 nm, or from about 1 nm to about 100 nm, or from about 10 nm to about 20 nm.

The aerogel fillers 120 can have porosities of at least about 50%, or more than about 90% to about 99.9%, in which the aerogel can contain 99.9% empty space. For example, the aerogel fillers 120 can suitably have an average porosity of from about 50% to about 99%, or from about 55% to about 99%, or from about 55% to about 90%. The aerogel fillers 120 can have an average surface area of about 100 m² per gram or greater, or ranging from about 400 m² per gram to about 1200 m² per gram, or ranging from about 600 m² per gram to about 800 m² per gram. The aerogel fillers 120 can have low mass densities, e.g., ranging from about 1 mg/cc to about 400 mg/cc, or from about 20 mg/cc to about 200 mg/cc, or from about 40 mg/cc to about 100 mg/cc.

Any suitable aerogel fillers can be used. In embodiments, the aerogel fillers can be, for example, selected from inorganic aerogels, organic aerogels, carbon aerogels, and mixtures thereof. In particular embodiments, ceramic aerogel fillers can be suitably used, including, but not limited to, silica, alumina, titania, zirconia, silicon carbide, silicon nitride, and/or tungsten carbide. The aerogel fillers can optionally be doped with other elements such as a metal. In some embodiments, the aerogel fillers can include aerogeis chosen from polymeric aerogeis, colloidal aerogels, and mixtures thereof.

In examples, aerogels can be commercially available from several sources. Aerogels prepared by supercritical fluid extraction or by subcritical drying are available from Cabot Corp. (Billerica, Mass.), Aspen Aerogel, Inc. (Northborough, Mass.), Hoechst, A.G. (Germany), American Aerogel Corp. (Rochester, N.Y.), and/or Dow Corning (Midland, Mich.).

Referring back to FIGS. 1A-1B, the aerogel fillers 120 can be physically dispersed in and/or chemically bonded to the polymeric material 140. For example, the aerogel fillers 120 can be simply mixed or dispersed in the polymeric material, but is not chemically bonded to (such as being crosslinked with) the polymer material. In another embodiment, the aerogel fillers can be chemically bonded to the polymer material, such as being crosslinked with the polymer material. In still another embodiment, the aerogel fillers can be have some particles that are simply mixed or dispersed in the polymeric material, while other particles are chemically bonded to the polymer material. As used herein, the aerogel particles being “bonded” to the polymer matrix refers to chemical bonding such as ionic or covalent bonding, and not to such weaker bonding mechanisms such as hydrogen bonding or physical entrapment of molecules that may occur when two chemical species are in close proximity to each other.

In embodiments, the polymer matrix/material 140 can include one or more polymers selected from the group consisting of a fluoroelastomer, a silicone elastomer, a thermoelastomer, a resin, a fluoroplastic, a fluororesin, and a combination thereof.

In embodiments, the polymer matrix/material 140 of the coating materials 100A-B can include fluoroelastomers. In specific embodiments, fluoroelastomers can be from the class of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and cure site monomer. These fluoroelastomers are known commercially under various designations such as VITON A®, VITON B®, VITON E®, VITON E 60C®, VITON E430®, VITON 910®, VITON GH®; VITON GF®; and VITON ETP®. The VITON® designation is a Trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer, such as those commercially available from DuPont. Other commercially available fluoropolymers can include FLUOREL 2170®, FLUOREL 2174®, FLUOREL 2176®, FLUOREL 2177® and FLUOREL LVS 76®, FLUOREL® being a registered trademark of 3M Company. Additional commercially available materials can include AFLAS™ a poly(propylene-tetrafluoroethylene), and FLUOREL II® (LII1900) a poly(propylene-tetrafluoroethylenevinylidenefluoride), both also available from 3M Company, as well as the Tecnoflons identified as FOR-60KIR®, FOR-LHF®, NM® FOR-THF®, FOR-TFS®, TH®, NH®, P757®, TNS®, T439®, PL958®, BR9151®, and TN505®, available from Ausimont.

Examples of three known fluoroelastomers can be (1) a class of copolymers of two of vinylidenefluoride, hexafluoropropylene, and tetrafluoroethylene, such as those known commercially as VITON A®; (2) a class of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and cure site monomer known commercially as VITON GH® or VITON GF®. The fluoroelastomers VITON GH® and VITON GF® can have relatively low amounts of vinylidenefluoride. The VITON GF® and VITON GH® can have about 35 weight percent of vinylidenefluoride, about 34 weight percent of hexafluoropropylene, and about 29 weight percent of tetrafluoroethylene, with about 2 weight percent cure site monomer.

In embodiments, the polymer matrix/material 140 can include polymers cross-linked with an effected curing agent (also referred to herein as cross-linking agent, or cross-linker) to form elastomers that are relatively soft and display elastic properties. For example, when the polymer matrix uses a vinylidene-fluoride-containing fluoroelastomer, the curing agent can include, a bisphenol compound, a diamino compound, an aminophenol compound, an amino-siloxane compound, an amino-silane, and/or a phenol-silane compound. An exemplary bisphenol cross-linker can be VITON® Curative No. 5 (VC-50) available from E.I. du Pont de Nemours, Inc. VC-50 can be soluble in a solvent suspension and can be readily available at the reactive sites for cross-linking with, for example, VITON®-GF (E.I. du Pont de Nemours, Inc.).

In embodiments, the coating materials 100A-B can include at least the above-described aerogel fillers 120 that are at least one of dispersed in or bonded to the polymer material 140. In particular embodiments, the aerogel fillers 120 can be uniformly dispersed in and/or bonded to the polymer material 140, although non-uniform dispersion or bonding can be used in embodiments to achieve specific goals. For example, in embodiments, the aerogel fillers can be non-uniformly dispersed or bonded in the polymer component to provide a high concentration of the aerogel fillers in surface layers, substrate layers, different portions of a single layer, or the like.

In embodiments, various other additive components including, conventional particle fillers, surfactants, defoamer agents, etc. can be optionally included in the disclosed coating materials 100A-B. As exemplarily shown in FIG. 1B, a plurality of particle fillers 130 can be dispersed within the polymer matrix 140 that already contains the aerogel fillers 120.

The particle fillers 130 can have dimensions on the micron and/or nano-scales. The particle fillers 130 can be organic, inorganic, or metallic and can include conventional composite filler materials of, for example, metals or metal oxides, including copper particles, copper flakes, copper needles, aluminum oxide, nano-alumina, titanium oxide, silver flakes, aluminum nitride, nickel particles, silicon carbide, silicon nitride, etc.

In embodiments, the type, porosity, pore size, and/or amount of aerogel fillers 120 can be chosen based upon the desired properties of the resultant coating materials 100A-B and upon the properties of the polymers and solutions thereof into which the aerogel fillers are combined. For example, conductive aerogel fillers, such as carbon aerogel fillers can be used to provide desirable physical, mechanical, and electrical properties that are otherwise difficult to obtain. In embodiments, aerogel fillers 120 can include nanometer-scale particles, which can occupy inter- and intra-molecular spaces within the molecular lattice structure of the polymer material 140, and thus can prevent water molecules from becoming incorporated into those molecular-scale spaces. In addition, the aerogel fillers 120 can interpenetrate or intertwine with the polymer material and thereby strengthen the polymeric lattice. Further, depending upon the properties of the aerogel fillers, the aerogel fillers can be used as is, or can be chemically modified.

Any suitable amount of the aerogel fillers 120 can be incorporated into the polymer material 140. For example, the aerogel fillers 120 can be present in an amount ranging from about 0.1% to about 30%, or from about 0.5% to about 20%, or from about 1% to about 10% by weight of the total coating materials 100A-B, to provide the coating materials with desired surface, mechanical and/or thermal properties, such as an average surface roughness Sq value ranging from about 0.1 μm to about 15 μm, or from about 0.5 μm to about 10 μm, or from about 1 μm to about 5 μm. The low density aerogel fillers can cover a significant portion of the polymer surface but do not conform with the exemplary elastomeric material to provide desirable surface roughness. This surface roughness can facilitate controlling of image gloss levels when the coating materials are used as fuser member materials during electrophotographic printing. For example, a series of fuser rolls with varying amounts of aerogel fillers can thus be produced allowing the customer to choose the gloss of the prints by selecting the appropriate fuser roll.

The coating materials 100A-B can provide desirable mechanical properties. For example, the coating materials 100A-B can have a tensile strength ranging from about 100 psi to about 350 psi, or from about 150 psi to about 300 psi, or from about 200 psi to about 250 psi; an ultimate elongation % ranging from about 30% to about 200%, or from about 50% to about 100%, or from about 70% to about 85%; a toughness ranging from about 50 in.-lbs./in.³ to about 300 in.-lbs./in.³, or from about 60 in.-lbs./in.³ to about 150 in.-lbs./in.³, or from about 75 in.-lbs./in.³ to about 125 in.-lbs./in.³; and an initial modulus ranging from about 150 psi to about 1000 psi, or from about 200 psi to about 600 psi, or from about 300 psi to about 500 psi. In one embodiment, the above-described mechanical properties can be measured using the ASTM D412 method as known in the art at a temperature of about 180° C.

The coating materials 100A-B can provide a desirable average thermal diffusivity ranging from about 0.01 mm²/s to about 0.2 mm²/s, or from about 0.02 mm²/s to about 0.1 mm²/s, or from about 0.03 mm²/s to about 0.08 mm²/s; and a desirable average thermal conductivity ranging from about 0.05 W/mK to about 0.2 W/mK, or from about 0.07 W/mK to about 0.17 W/mK, or from about 0.09 W/mK to about 0.15 W/mK. The coating materials 100A-B can provide desirable surface energy ranging from about 15 mN/m² to about 30 mN/m², or from about 18 mN/m² to about 25 mN/m², or from about 20 mN/m² to about 23 mN/m².

In various embodiments, the disclosed coating materials 100A-B can be used in any suitable electrophotographic members and devices including, e.g., a fusing member. The term “fusing member” as used herein refers to fuser members including fusing rolls, belts, films, sheets, and the like; donor members, including donor rolls, belts, films, sheets, and the like; and pressure members, including pressure rolls, belts, films, sheets, and the like; and other members useful in the fusing system of an electrostatographic or xerographic, including digital, machine. The fuser member of the present disclosure can be employed in a wide variety of machines, and is not specifically limited in its application to the particular embodiment depicted herein.

In exemplary embodiments, the coating materials 100A-B can be used as a topcoat layer for a fuser member and/or a pressure member in a fusing system. Prints obtained from such fusing system can thus provide desirable gloss levels, e.g., having a reduced gloss level as compared with prints provided by conventional materials and devices. The topcoat layer using the disclosed coating materials as shown in FIGS. 1A-1B can then be referred to as a gloss-controlling topcoat layer.

As used herein, the term “gloss-controlling topcoat layer” refers to a coating layer configured as a topcoat layer for a fuser member and/or a pressure member used in a fusing system, wherein, after a print medium having unfixed toner images thereon passes through a contact arc formed between the fuser member and the backup member, the fused toner images on the print medium (i.e., the print) can have a controllable gloss level.

The gloss level can be measured by a digital high-precision glossmeter (manufactured by Murakami Color Research Laboratory Co., Ltd.) at an incident angle of 75°. The measured gloss level is therefore referred to as G75 gloss level, as known to one of ordinary skill in the art. In embodiments, the controllable gloss level of a print can be about 90 ggu or less, or range from about 90 ggu to about 1 ggu, or range from about 70 ggu to about 10 ggu, or range from about 60 ggu to about 40 ggu.

In this manner, by adjusting, e.g., amount, property, and/or type of the aerogel fillers that are incorporated in the exemplary polymer material, the resulting coating materials can have adjustable surface/bulk properties and can provide desirable gloss level of the prints.

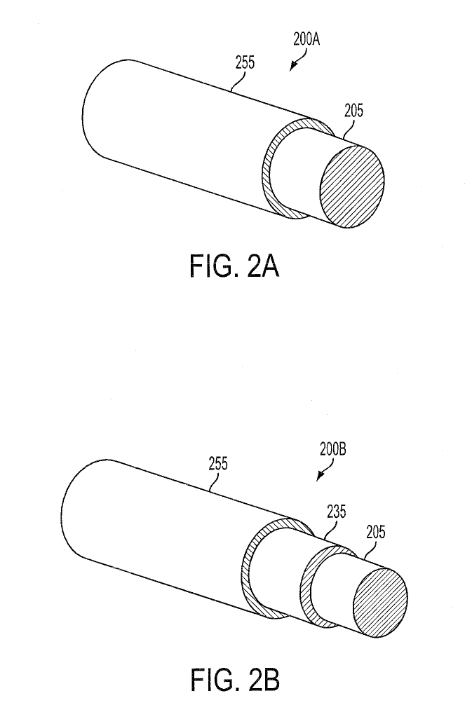

FIG. 2A depicts an exemplary fusing member 200A in accordance with various embodiments of the present teachings. The member 200A can be, for example, a fuser member, a pressure member, and/or a donor member used in electrophotographic devices and in an exemplary form of a roll, a drum, or a drelt.

As shown in FIG. 2A, the member 200A can include a substrate 205 and a gloss-controlling topcoat layer 255 formed over the substrate 205.

The substrate 205 can be made of a material including, but not limited to, a metal, a plastic, and/or a ceramic. For example, the metal can include aluminum, anodized aluminum, steel, nickel, and/or copper. The plastic can include polyimide, polyester, polyetheretherketone (PEEK), poly(arylene ether), and/or polyamide.

As illustrated, the member 200A can be, for example, a fuser roller including the gloss-controlling topcoat layer 255 formed over an exemplary core substrate 205. The core substrate can take the form of, e.g., a cylindrical tube or a solid cylindrical shaft, although one of the ordinary skill in the art would understand that other substrate forms, e.g., a belt substrate, can be used to maintain rigidity and structural integrity of the member 200A.

The gloss-controlling topcoat layer 255 can include, for example, the coating material 100A-100B as shown in FIGS. 1A-1B. The topcoat layer 255 can thus include a plurality of aerogel fillers, and optionally particle fillers such as metals or metal oxides, dispersed within a polymer matrix. As shown in FIG. 2A, the gloss-controlling topcoat layer 255 can be formed directly on the substrate 205. In various other embodiments, one or more additional functional layers, depending on the member applications, can be formed between the gloss-controlling topcoat layer 255 and the substrate 205.

For example, the member 200B can have a 2-layer configuration having a compliant/resilient layer 235, such as a silicone rubber layer, disposed between the gloss-controlling topcoat layer 255 and the core substrate 205. In another example, the exemplary fuser member can include an adhesive layer (not shown), for example, formed between the resilient layer 235 and the substrate 205 or between the resilient layer 235 and the gloss-controlling topcoat layer 255.

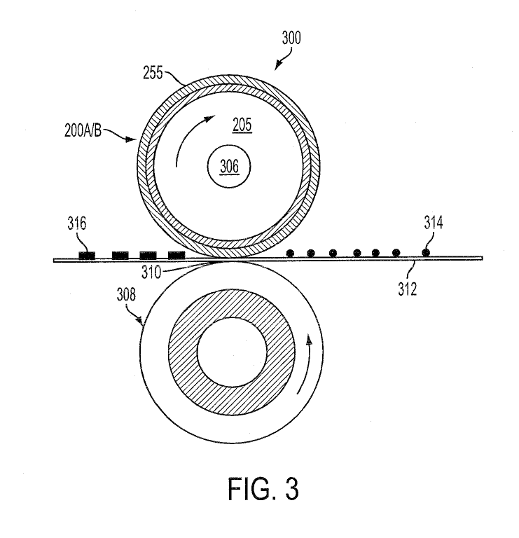

In one embodiment, the exemplary fuser member 200A-B can be used in a conventional fusing system to improve fusing performances as disclosed herein. FIG. 3 depicts an exemplary fusing system 300 using the disclosed member 200A or 200B of FIGS. 2A-2B.

The exemplary system 300 can include the exemplary fuser roll 200A or 200B having a gloss-controlling topcoat layer 255 over a suitable substrate 205. The substrate 205 can be, for example, a hollow cylinder fabricated from any suitable metal. The fuser roll 200 can further have a suitable heating element 306 disposed in the hollow portion of the substrate 205 which is coextensive with the cylinder. Backup or pressure roll 308, as known to one of ordinary skill in the art, can cooperate with the fuser roll 200 to form a nip or contact arc 310 through which a print medium 312 such as a copy paper or other print substrate passes, such that toner images 314 on the print medium 312 contact the gloss-controlling topcoat layer 255 during the fusing process. The fusing process can be performed at a temperature ranging from about 60° C. (140° F.) to about 30° C. (572° F.), or from about 93° C. (200° F.) to about 232° C. (450° F.), or from about 160° C. (320° F.) to about 232° C. (450° F.). Optionally, a pressure can be applied during the fusing process by the backup or pressure roil 308. Following the fusing process, after the print medium 312 passing through the contact arc 310, fused toner images 316 can be formed on the print medium 312.

As disclosed herein, the gloss output of the fused toner images 316 on the print medium 310 can be controlled by using the aerogel filler-containing coating materials as the topcoat layer of the fuser member. Depending on the selected aerogel fillers or a selected combination of the aerogel fillers and/or the polymers selected for the polymer matrix, suitable properties of the topcoat layer and suitable levels of image gloss can be obtained as desired. For example, conventional fuser materials produce images with a gloss level limited to between 60 to 90 ggu in iGen configurations, while the exemplary fuser materials including aerogel fillers can produce images with controllable, e.g., reduced, gloss level of the fused or printed images of less than about 90 ggu and covering a controllable range of from about 90 ggu to about 1 ggu as disclosed herein.

Various embodiments can also include methods for forming the disclosed coating materials (see FIGS. 1A-1B) and for forming the exemplary fusing members (see FIGS. 2A-2B and FIG. 3).

For example, to form the disclosed fuser member, a liquid coating dispersion can be prepared to include, for example, a desired polymer (e.g., VITON® GF), aerogel filler(s), and other optional additive components in suitable solvent depending on the selected polymer and/or the aerogel fillers.

Various solvents including, but not limited to, water, methyl ethyl ketone (MEK), methyl isobutyl ketone (MIBK), methyl-tertbutyl ether (MTBB), methyl n-amyl ketone (MAK), tetrahydrofuran (THF), Alkalis, methyl alcohol, ethyl alcohol, acetone, ethyl acetate, butyl acetate, or any other low molecular weight carbonyls, polar solvents, fireproof hydraulic fluids, along with the Wittig reaction solvents such as dimethyl formamide (DMF), dimethyl sulfoxide (DMSO) and N-methyl 2 pyrrolidone (NMP), can be used to prepare the liquid coating dispersion.

The liquid coating dispersion can be formed by first dissolving the polymer, e.g., a fluoroelastomer, in a suitable solvent, followed by adding a plurality of aerogel fillers and/or other optional components into the solvent in an amount to provide desired properties, such as a desired fusing properties, thermal conductivities, or mechanical robustness. In another example, the liquid coating dispersion can be formed by first mixing the polymer and a plurality of aerogel fillers, followed by dissolving or dispersing the mixture in an appropriate solvent as described above.

In various embodiments, when preparing the liquid coating dispersion, a mechanical aid, such as an agitation, sonication and/or attritor ball milling/grinding, can be used to facilitate the mixing of the dispersion. For example, an agitation set-up fitted with a stir rod and Teflon blade can be used to thoroughly mix the aerogel fillers with the polymer in the solvent, after which additional chemical curatives, such as curing agent, and optionally other particle fillers such as metal oxides, can be added into the mixed dispersion.

The fuser member can then be formed by applying an amount of the liquid coating dispersion to a substrate, such as the substrate 205 in FIGS. 2A-2B. The application of the liquid coating dispersion to the substrate can include a process of deposition, coating, printing, molding, and/or extrusion. In an exemplary embodiment, the liquid coating dispersion, i.e., the reaction mixture, can be spray coated, flow coated, and/or injection molded onto the substrate.

The applied liquid coating dispersion can then be solidified, e.g., by a curing process, to form a coating layer, e.g., the layer 255, on the substrate, e.g., the substrate 205 of FIG. 2. The curing process can include, for example, a drying process and/or a step-wise process including temperature ramps. Depending on the dispersion composition, various curing schedules can be used. In various embodiments, following the curing process, the cured member can be cooled, e.g., in a water bath and/or at room temperature.

In embodiments, the solidified coating layer, i.e., the topcoat layer of the fuser member can have a thickness ranging from 5 μm to about 100 μm, or from about 10 μm to about 50 μm, or from about 20 μm to about 40 μm. In embodiments, additional functional layer(s) (see 235 of FIG. 2B) can be formed prior to or following the formation of the coating material over the substrate.

### EXAMPLES

### Example 1

### Liquid Formulation of Aerogel Fillers in VITON

Silica silicate VM2270 aerogel powder was obtained from Dow Corning (Midland, Mich.). The powder contained about 5-15 μm particles having >90% porosity, about 40-100 kg/m³ bulk density, and about 600-800 m²/g surface area. Topcoat formulations were prepared including VITON-GF fluoropolymer, about 5 pph AO700 crosslinker, and respectively about 0, 3, and 5 pph of VM2270 aerogel powder in a solvent of methyl isobutylketone (MIBK).

### Example 2

### Topcoat Layer Formation by Flow Coating

Fuser roll topcoat layer was formed by applying a polymer solution including approximately 10-30% total solids weight basis in a pre-metered coating flow, dispensed between a blade and rotating fuser roll surface (rpm range between 40-200). The blade provided flow leveling around the roll circumference of the fuser substrate. The dispensing head and metering blade traversed along the length of the roll having a speed of about 2-20 mm/s so that the entire roll surface was coated in a spiral pattern. Successful flow coating conducted in this manner depended on coating rheology, blade angle, tip pressure, traverse speed, dispense rate and/or other factors as known to one of ordinary skill in the field of liquid film coating. The solvent evaporated from the coated roll leaving a dry film including polymer, aerogel ceramic particles, and/or other additives. After drying, the processed roll was placed in a Grieve oven to thermally cure the formed topcoat over the roll substrate. Standard VITON curing conditions were used.

### Example 3

### Surface Roughness and Roll Gloss

Table 1 compares gloss levels of prints between fuser rolls having various topcoat layers. As shown, the topcoat layers can have filler materials including, carbon nanotubes (CNT), Teflon (FEP, PEVE, PFA) and the disclosed exemplary aerogel silica fillers having a concentration of about 3% and 5%.

TABLE 1

| Sample # | Topcoat Layer | Gloss 75 degree |
|---|---|---|
| 10 | VITON | 68.93 |
| 20 | VITON/CNT/FEP | 56.77 |
| 30 | VITON/CNT/PEVE | 78.43 |
| 40 | VITON/CNT/PFA | 82.23 |
| 50 | VITON/3% Aerogel | 30.63 |
| 60 | VITON/5% Aerogel | 14.43 |

As compared with the topcoat layer containing VITON only (see sample No. 10), and VITON containing non-aerogel fillers (see sample Nos. 20, 30, and 40), use of the topcoat layer containing aerogel silica fillers (see sample Nos. 50 and 60) can significantly reduce the gloss level of the resulting prints.

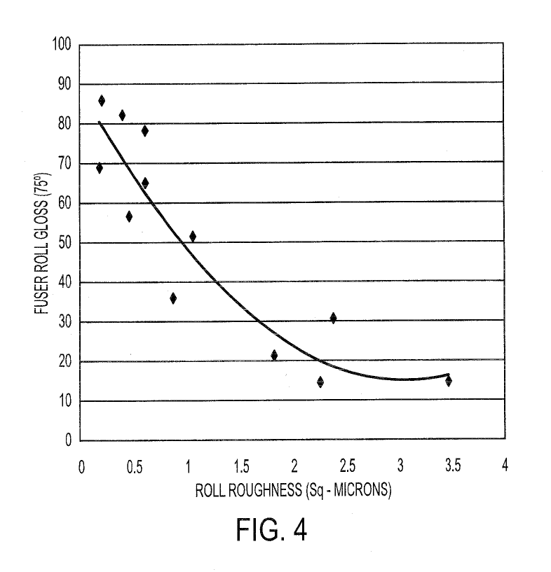

FIG. 4 depicts a relationship between the surface roughness of the gloss-controlling topcoat layer and the gloss level of the resulting prints using the disclosed aerogel filler-containing VITON topcoat layer in accordance with various embodiments of the present teachings. As indicated, an increased surface roughness of the disclosed fuser roll can result in a reduced gloss level of the resulting prints.

### Example 4

### Experimental Fusing Data

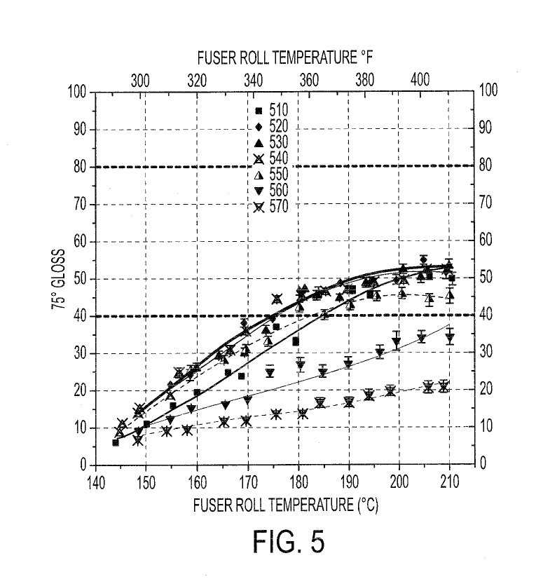

Unfused images of iGen toner at 0.50 mg/cm² on exemplary print media of CX+ 90 gsm paper and DCEG 120 gsm paper were fused with the iGen3 fusing fixture over a range of temperatures with the process speed set to about 468 mm/s. Print gloss results are summarized in FIG. 5 for samples fused onto the print medium of CX+ 90 gsm paper and the print medium of DCEG 120 gsm paper, respectively. The two rolls with aerogel silica fillers (see 560 and 570) had significantly lower gloss than the iGen3 control roll (see 510) and the other rolls made with various fillers (see 520, 530, 540, and 550). That is, increasing the amount of aerogel silica fillers in the fuser topcoat layer can decreased the gloss level of the resulting prints.

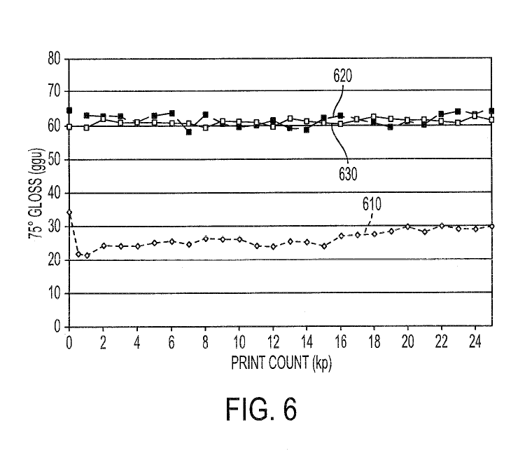

FIG. 6 shows gloss level as a function of print count for fuser roll with 5% aerogel fillers (see 610) and for conventional iGen3 fuser rolls (see 620 and 630). The disclosed fuser roll with aerogel fillers in the VITON topcoat can have lower gloss level, as compared with conventional fuser roll. FIG. 6 indicates a gloss difference of about 30 ggu between conventional iGen3 rolls and the disclosed fuser roll. Additionally, the matte effect of the disclosed fuser roll with aerogel fillers in the VITON topcoat can be maintained for about thousands of prints. Experimentally, the rolls used in FIG. 6 was run in iGen3 printer #295 using DCEG 120 gsm paper as the print medium for 25 kp and gloss of the cyan stripe was measured.

Further, FTIR measurements (data not shown) indicated that use of aerogel fillers in the fuser topcoat layer can reduce surface contamination, as compared with conventional fuser rolls.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.”

Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A fuser member comprising:
a substrate; and
a topcoat layer disposed over the substrate,
wherein the topcoat layer comprises a plurality of aerogel fillers disposed in a polymer matrix, and wherein the plurality of aerogel fillers is present in an amount ranging from about 0.1% to about 30% by weight of the total topcoat layer to provide the topcoat layer with an average surface roughness Sq value ranging from about 0.1 μm to about 15 μm.

2. The member of claim 1, wherein the surface roughness provides a fused toner image with a gloss level in a range from about 90 ggu to about 1 ggu.

3. The member of claim 1, wherein the plurality of aerogel fillers is selected from the group consisting of inorganic aerogels, organic aerogels, carbon aerogels, and mixtures thereof.

4. The member of claim 1, wherein the plurality of aerogel fillers are formed of a material selected from the group consisting of alumina, silica, zirconia, titania, silicon carbide, silicon nitride, tungsten carbide, and a combination thereof.

5. The member of claim 1, wherein the plurality of aerogel fillers has an average porosity greater than or equal to about 50%.

6. The member of claim 1, wherein the plurality of aerogel fillers has an average surface area ranging from about 400 m²/g to about 1200 m²/g.

7. The member of claim 1, wherein the plurality of aerogel fillers is at least one of physically dispersed in or chemically bonded to a polymer material of the polymer matrix.

8. The member of claim 1, wherein the plurality of aerogel fillers has an average particle size ranging from about 5 nm to about 50 μm.

9. The member of claim 1, wherein the plurality of aerogel fillers has an average mass density ranging from about 1 mg/cc to about 400 mg/cc.

10. The member of claim 1, wherein the polymer matrix comprises one or more polymers selected from the group consisting of a fluoroelastomer, a silicone elastomer, a thermoelastomer, a resin, and a combination thereof, and
wherein the fluoroelastomer comprises a cure site monomer and a monomeric repeat unit selected from the group consisting of a vinylidene fluoride, a hexafluoropropylene, a tetrafluoroethylene, a perfluoro(methyl vinyl ether), a perfluoro(propyl vinyl ether), a perfluoro(ethyl vinyl ether), and a combination thereof.

11. The member of claim 1, further comprising one or more particle fillers dispersed in the polymer matrix, wherein the one or more particle fillers are selected from the group consisting of copper, aluminum oxide, nano-alumina, titanium oxide, silver, aluminum nitride, nickel, silicon carbide, silicon nitride, and a combination thereof.

12. The member of claim 1, wherein the substrate is a cylinder, a roller, a drum, a belt, a plate, a film, a sheet, or a drelt.

13. The member of claim 1, wherein the substrate is formed of a material selected from the group consisting of a metal, a plastic, and a ceramic, wherein the metal comprises a material selected from the group consisting of an aluminum, an anodized aluminum, a steel, a nickel, a copper, and a mixture thereof, and wherein the plastic comprises a material selected from the group consisting of a polyimide, a polyester, a polyetheretherketone (PEEK), a poly(arylene ether), a polyamide, and a mixture thereof.

14. The member of claim 1, further comprising a resilient layer positioned between the substrate and the topcoat layer, wherein the resilient layer comprises silicone rubber.

15. A fusing method of reducing gloss level in prints comprising:
forming a contact arc between a coating material of a fuser roll and a pressure member, wherein the coating material comprises a plurality of aerogel fillers disposed in a fluoroelastomer, the plurality of aerogel fillers having an amount ranging from about 0.5% to about 20% by weight of the total coating material to provide the coating material with an average surface roughness Sq value ranging from about 0.5 μm to about 10 μm, and
passing a print medium through the contact arc such that a toner image on the print medium contacts the coating material and is fused on the print medium, wherein the fused toner image on the print medium have a controllable gloss level in a range between about 70 ggu and about 10 ggu.

16. The method of claim 15, wherein the coating material has a thickness ranging from 5 μm to about 100 μm.

17. The method of claim 15, wherein the coating material has a thermal diffusivity ranging from about 0.01 mm²/s to about 0.2 mm²/s, and a thermal conductivity ranging from about 0.05 W/mK to about 0.2 W/mK.

18. A fuser member comprising:
a substrate; and
a topcoat layer disposed over the substrate,
wherein the topcoat layer comprises a fluoroelastomer matrix and a plurality of aerogel fillers, the plurality of aerogel fillers disposed in the fluoroelastomer matrix in an amount to provide the topcoat layer with an average surface roughness Sq value ranging from about 1 μm to about 5 μm; and
wherein the topcoat layer is a gloss-controlling topcoat layer configured to fuse a toner image on a print medium with a gloss level ranging from about 70 ggu to about 10 ggu.

19. The member of claim 18, wherein the gloss-controlling topcoat layer has a tensile strength ranging from about 100 psi to about 350 psi, an ultimate elongation % ranging from about 30% to about 200%, a toughness ranging from about 50 in.-lbs./in.³ to about 300 in.-lbs./in.³, and an initial modulus ranging from about 150 psi to about 1000 psi.

20. The member of claim 18, wherein the plurality of aerogel fillers are formed of a material selected from the group consisting of alumina, silica, zirconia, titania, silicon carbide, silicon nitride, tungsten carbide, and a combination thereof.
